(19) United States
(12) Patent Application Publication
(10) Pub. No.: US 2024/0413296 A1
(43) Pub. Date: Dec. 12, 2024

(54) Roller for Use in a Dry Coating Process for Producing Electrodes

(71) Applicants: Matthews International GmbH, Vreden (DE); Matthews International Corporation, Pittsburgh, PA (US)

(72) Inventors: Thomas HACKFORT, Ahaus-Altstätte (DE); Thorsten BÖING, Rhede (DE); Stefan TERBILLE, Vreden (DE); Carsten KLEINGRIES, Vreden (DE); Rene WOLTERS, Stadtlohn (DE)

(21) Appl. No.: 18/706,034

(22) PCT Filed: Feb. 22, 2022
(86) PCT No.: PCT/DE2022/100140

§ 371 Date: Apr. 30, 2024

Related U.S. Application Data
(60) Provisional application No. 63/275,845, filed on Nov. 4, 2021.
(60) Provisional application No. 63/277,477, filed on Nov. 9, 2021.

(51) Int. Cl. H01M 4/04; B05C 11/02; B30B 3/00

(52) U.S. Cl. CPC H01M 4/0435; B30B 3/005; B05C 11/025

(57) ABSTRACT

The invention relates to a roller (1) for use in a dry coating process to produce electrodes, comprising: a roller core (3) consisting of a core material; a roller shell (4) consisting of a shell material, the roller shell surrounding the roller core at least in sections; the shell material having a greater hardness than the core material; and the roller core including a device for tempering the roller shell.

The invention relates to a roller for use in a dry coating process to produce electrodes, comprising: a roller core consisting of a core material; a roller shell consisting of a shell material, the roller shell surrounding the roller core at least in sections.

Until now, electrodes (anodes and cathodes) for batteries and supercapacitors have mainly been processed using wet chemistry. For this purpose, the respective active materials, conductive additives and binders are dispersed in a liquid phase (water- or solvent-based) and the resulting paste is then applied to the current collector (film or foam structure). In a further process step, the electrode is dried. The dryer lines used are long and energy-intensive to operate. In addition, there is the necessary peripheral equipment, which is essential for separating the sometimes toxic solvents from the exhaust air to comply with the applicable environmental regulations.

A new production technique for battery electrodes is the dry coating process. This does not require the use of solvents and uses less energy. The dry coating process therefore has great potential for reducing production costs. The dry coating process includes two essential steps. First, the powders of the active materials, additives and binders are mixed in a dry mixing process. The decisive factor here is the structure and distribution of the polymer binder. With optimum distribution of polymer fibrils, mechanically stable, free-standing films are obtained even with low binder contents of less than 5 percent by weight. In a second process step, the powdery material resulting from the mixing process can now be pressed to form electrode films approx. 50-100 μm thick, either free-standing or on a current collector as a substrate. The uniform distribution of the powder material is of great importance here. Particularly when using different starting powders, the challenge is to process them continuously into wound electrode films.

A major challenge in the field of electrode production using the dry coating process is to produce the electrodes precisely and with minimal thickness variations. The large overall size of the rollers required to produce the electrodes economically, combined with the thermal expansion of roller materials, can lead to significant changes in the roller diameter, which has a direct influence on the thickness and other dimensions of the electrodes. However, the exact thickness of the electrodes is a decisive quality feature in the production of electrochemical cells such as Li-ion cells. The thickness of the electrodes must be uniform over their entire length and width. When producing Li-ion cells such as cylindrical, prismatic or pouch cells, electrode foils are prepared and laminated with other layers such as the separator and current collectors before the entire laminated continuous foil is cut to a specific length. The cut composite film is wound into a lithium-ion cell. Any variation in the thickness of the electrode over its length or width will change the size of the wrapped film layers resulting from the above process, which can lead to an incorrectly wrapped body. For these reasons, there is a need for improved systems, processes and devices to ensure the accuracy of the electrode thickness.

Another problem in the field of electrode production using the dry coating process is that dirt, particles or, for example, clumped electrode coating material can lead to damage of the roller surface. When the particles are deposited on the surface of rollers coming into contact with one another during machine operation, the particles between the rollers are pressed together. When such particles are pressed together between the rollers, they can exert large forces locally concentrated on the surface of the rollers and damage them if the permissible surface pressure is exceeded. This is known as contact fatigue and manifests itself in the form of fatigue holes on both surfaces of the rollers between which the roller gap is formed. Contact fatigue has a negative effect on the quality of the electrodes as the rollers exhibit surface defects. There is a need to prevent the formation of pits, surface deformations and other undesirable microstructural features that accumulate on the surface of rollers in a working production environment. Given the need for a precise and uniform surface of the electrodes, even minor damage caused by contaminants can affect the function of the electrodes when they are assembled into final products and put into service. Therefore, the roller hardness must be increased to prevent damage caused by the concentrated pressure of the impurities.

It is therefore necessary to provide a roller to produce electrodes which, on the one hand, ensures a uniform thickness of a material web passing through the roller gap and, on the other hand, is resistant to damage to the roller surface.

This means that the roller gap must be kept constant regardless of the load and the external environment, for example by maintaining a precise, uniform temperature across the entire roller gap. On the other hand, the roller must have the hardest possible surface.

It is therefore the object of the present invention to provide a roller to produce electrodes by means of which electrodes of uniform thickness and quality can be produced.

Accordingly, it is provided that the shell material has a greater hardness than the core material and that the roller core has a device for tempering the roller shell. This configuration has the advantage that the roller has a high hardness due to the roller shell on its surface for generating the electrode and offers good processability due to the relatively softer core, so that the roller core can be easily machined, in particular machined to accommodate the device for tempering the roller shell. This provides a solution to the challenge that the shaft should on the one hand have the greatest possible hardness and on the other hand have a device for influencing the roller gap. The present invention thus fulfills conflicting requirements for both properties. A hard shaft alone is difficult to machine, so that a tempering function cannot be realized. A soft shaft alone, on the other hand, is not suitable to produce dry electrodes.

For example, it can be provided that the roller core or the base body is made of slightly hardened steel, for example tempered steel such as 42CrMo4, and therefore has good workability and is easy to mill, for example. The roller core or the base body can also consist of or have a nickel-based alloy. Furthermore, it can be provided that the roller shell to be made of a hard material, for example a hardened cold work steel with maximum resistance. Good workability of the shell material is not necessary and expressly undesired. The shell can be shrunk or clamped onto the roller core. A further advantage of this configuration is that solid shafts made from pre-forged cold work steel cannot be produced in the size and hardness required for the produce of electrodes. To produce batteries, roller bodies with large diameters are required. Such bodies can only be hardened from the outside using a water shower or oil bath. However, solid shafts of this size have a very high heat capacity. Once they are heated in the hardening furnace, quenching them to the desired extent is not possible, as the roller surface is repeatedly relaxed due to the heat flowing from the inside of the roller body. In this way, only a toughened structure can be achieved on the roller surface in a range up to 3-4 mm deep. It is therefore advantageous to design the roller shell as a tubular structure and to mount it on the roller core, as the roller shell can be heated and quenched from the inside and outside at the same time in this way and does not have such a large heat capacity as a solid shaft, so that correspondingly less heat flows from the inside of the roller shell during quenching than with a solid shaft. This enables through-hardening of the tube up to 20 mm or more. The configuration of the shaft with a soft roller core and a hard roller shell in the form of a tube construction mounted on the roller core has two significant advantages. Firstly, as described above, better through-hardening can be achieved when using a roller shell, as this can be quenched both from the inside and from the outside, particularly at the same time. This allows a greater thickness of the hardening zone. On the other hand, it is not necessary to introduce cooling channels into the hard roller shell. Instead, they can be provided exclusively in the softer core.

The invention further relates to a roller for use in a dry coating process to produce electrodes, comprising a roller core consisting of a core material: a roller shell consisting of a shell material, the roller shell surrounding the roller core at least in sections; the shell material having a greater hardness than the core material; wherein the roller shell and the roller core are designed as separate components and the essentially tubular roller shell is fastened in a force-locking and/or form-locking manner on the roller core; and wherein the roller shell consists of a curable steel, such as a cold-work steel, and is through-hardened on its surface to a depth of at least 5 mm. However, if the shell material is through-hardened to a depth of several millimeters, for example at least 5 mm, the advantage is that hard particles are prevented from pushing through the hardened coating. With smaller coating thicknesses, on the other hand, it can happen that it is not the coating itself that gives way under a local pressure peak, but rather the softer roller core material under the coating that fails if the surface pressure in the roller gap is too high. This effect can be avoided by providing a minimum thickness for the coating or the hardened roller shell.

The invention also relates to a roller for use in a dry coating process to produce electrodes, comprising: a roller core consisting of a core material; a roller shell consisting of a shell material, the roller shell surrounding the roller core at least in sections; and wherein the roller core has a device for tempering the roller shell; wherein the device for tempering the roller shell has a plurality of independently segmented tempering zones in the axial direction of the roller, wherein individual temperatures can be set in the individual tempering zones. During electrode production, temperature fluctuations or material distribution fluctuations can occur across the roller gap. This can lead to local irregularities in the size of the roller gap. For example, the roller gap in the middle of the roll can be temporarily narrower than the roller gap in the outer areas of the roll pairing due to certain operating fluctuations. This difference can be compensated for by generating a higher temperature in the edge areas of the roller gap by controlling the tempering zones in the edge areas accordingly, as the higher temperatures generated also cause the rollers in the corresponding areas to expand further and reduce the roller gap. If the roller gap, on the other hand, is larger in the central area than in the edge areas, the tempering zones in the central roller area can be controlled in such a way that the roller gap in the central area is reduced as a result of the higher temperature.

It can be provided that the shell material is applied as a coating to the roller core or the roller shell. The coating can comprise chromium, diamond-like carbon (DLC), tungsten carbide or a metal matrix composite material such as a tungsten carbide/cobalt alloy or a chromium carbide/nickel-chromium composite material. By CVD coating the calender roll with a DLC coating and a PVD coating with tungsten carbide, the roller hardness can be increased to prevent damage caused by the high pressure exerted on the rolls by impurities. The thickness of the coating can be between 1 μm and 50 μm.

It can be provided that coating the roller is carried out in a vacuum environment. In a negative pressure environment, the uncoated roller can be exposed to volatile precursor substances. The volatile precursors can comprise one or more of tungsten hexachloride (WCl6) with hydrogen (H2) and methane (CH4) or alternatively WCL6 with H2 and methanol (C3OH). In this way, a tungsten carbide layer can be deposited. As described above, tungsten carbide can be deposited by chemical vapor deposition, but other CVD processes can also be used, e.g. Plasma Activated Chemical Vapor Deposition (PACVD). Once the deposition is complete, the roller can be removed from the low-pressure environment.

Furthermore, an underlayer can be provided between the roller surface and the coating, which offers additional protection or surface adhesion of the coating. The underlayer can have one or more diamond-like coatings (DLC), tungsten carbide (WC) or copper (Cu). The composition and microstructure of the diamond-like coating can be customized according to the requirements for surface hardness, chemical resistance, toughness and other desired properties. The diamond-like coating may include one or more of the following forms: ta-C (tetrahedrally bonded hydrogen-free amorphous carbon), a-C:H (amorphous carbon with hydrogen, a-C:H:Me (Me=W, Ti, metal-doped amorphous carbon with hydrogen), a-C:H:Si (a Si-doped amorphous carbon with hydrogen), form a-C:H:X (a non-metal-doped amorphous carbon with hydrogen), fonn a-C:Me (Me=Ti, metal-doped hydrogen-free amorphous carbon), form ta-C:H (a tetrahedrally bonded amorphous carbon with hydrogen).

It can also be provided that the roller shell has a hardness of at least 53 HRC, preferably at least 57 HRC, particularly preferably at least 62 HRC.

In addition, it can be provided that the roller shell and the roller core are designed as separate components and that the essentially tubular roller shell is attached to the roller core in a force-fit and/or form-fit manner.

The roller shell can be fixed to the roller core by means of shrinking and/or cold expansion. For heat shrinking or cold expansion, the roller shell and the roller core must be designed in such a way that they are oversized at room temperature. Once the roller shell is heated or the roller core is cooled, a clearance is created between the two components so that the roller shell can be pushed onto the roller core. During cold stretching, the roller core is reduced in diameter by cooling for the shrinking process. When the roller shell cools down, it shrinks and encloses the roller core tightly. This therefore results in a shrink connection between the two components after the two components have been brought back to normal temperature.

It can also be provided that the roller shell is fixed to the roller core by means of a clamp connection.

It can also be conceived that the roller shell has a wall thickness of at least 10 mm, preferably at least 15 mm, particularly preferably at least 20 mm. Moreover, it can be provided that the coating is applied to the roller shell.

It can be provided that the roller shell consists of a curable steel, such as a cold work steel, and that it is through-hardened on its surface at least to a depth of at least 5 mm.

In particular, it can be provided that the roller shell is through-hardened across the entire cross-section of the pipe wall.

It can further be provided that the roller core consists of an easily machinable steel, such as a heat-treatable steel, e.g. 42CrMo4, or a case-hardening steel.

It can also be conceived that the device for tempering the roller shell has at least one heating and/or cooling element integrated into the roller core. It can also be provided that the device for tempering the roller shell is an inductive heating element. The device for tempering the roller shell can be configured in such a way that a predetermined operating temperature of the roller can be maintained during production operation. By setting a predetermined operating temperature, it is possible to adjust the roller during operation to a thermal expansion that correlates with the operating temperature. The device for tempering the roller shell can be a resistance element. For example, the device for tempering the roller shell can be a resistance coil. Alternatively, the device for tempering the roller shell can be inductive. It can also be conceived that several types of heating elements can be combined to set a specific temperature in the roller. The device for tempering the roller shell can be embedded in the roller at a constant depth below the roller surface to heat the roller surface evenly. For example, the device for tempering the roller shell can be arranged on the center axis of the roller or in a cavity surrounding the center axis of the roller.

The device for tempering the roller shell can include several heating elements. The heating elements can be encased in electrical insulation to ensure that the electrical current remains within the heating element and is not conducted through the roller. The electrical insulation can be electrically insulating and thermally conductive. The electrical insulation may include ceramics such as silica, alumina, steatite (magnesium silicate mineral), cordierite (a mineral containing iron, magnesium, aluminum and silicon, but not iron in synthetic form) and polymers. If a polymer is used, it may contain a thermally conductive but electrically insulating component, such as aluminum oxide or boron nitride. Since the roller may undergo uniform cyclic bending during operation, the insulation can be flexible, such as a fiberglass or polymer, or it can be omitted, as is possible with inductive heating elements.

The roller core can be hollow and contain a gas, such as air. The electric heating element can be located within the core. The core can have an opening that allows the circulation of a gas or fluid to control the temperature of the roller.

The heating element can be electrically connected to a power source outside the roller. For example, the power interface can consist of electrical contacts at both ends of the roller. Alternatively, the roller only has an electrical contact at one of its ends.

The roller can also include one or more air cooling channels. The cooling channels can extend through the roller core. The channels can be passively or actively cooled with a cooling gas or liquid such as compressed air, nitrogen or other substances, using a system external to the roller. The cooling channels can be supplied with the cooling medium by an active component such as a fan, blower, pump or compressor. The cooling medium can circulate during operation to provide additional control over the temperature of the roller. The cooling gas can be provided at ambient temperature (e.g. approx. 18° C. to approx. 24° C., or approx. 20° C.), higher than ambient temperature or lower than ambient temperature.

The roller can also include one or more sensors for temperature measurement. The temperature sensor can be a resistance temperature sensor. For example, a single temperature sensor can be located either centrally in the roller or closer to the operating surface of the roller, i.e. closer to the roller surface. It is also possible that the temperature sensor or sensors are mounted outside the roller and measure the temperature emitted by the roller.

The heating element, the active cooling elements and/or the temperature sensors can be integrated into a control circuit or a regulating circuit outside the roller. The control circuit can comprise one or more processors, storage media for storing data and programming instructions/configurations as well as communication interfaces.

It can also be provided that the device for tempering the roller shell comprises a plurality of independently segmented tempering zones in the axial direction of the roller, wherein individual temperatures can be set in the individual tempering zones.

Using the individual tempering zones, it is possible to vary the outer diameter of the roller at different points across the width of the roller to produce an electrode with as uniform a thickness as possible across the entire width of the roller gap in response to locally varying operating parameters.

Each tempering zone can include one or more heating elements that do not overlap with other zones. Each heating element can have a separate power supply. For example, the device for tempering the roller shell can include a plurality of axially adjacent inductors, which are accommodated in the roller core. Each inductor can include a separate electrical connection or a separate power supply. Furthermore, a separate temperature sensor can be assigned to each inductor to detect the temperature locally. The data from the temperature sensors can be transmitted to a higher-level control device via a data cable on one end face.

It can be provided that the roller core has an axial bore, in which the at least one heating and/or cooling element is accommodated.

Alternatively, it can be provided that the device for tempering the roller shell is a temperature radiator housed in the axial bore of the roller core.

It can further be provided that the roller core has functional bores in the form of fluid channels, which run at least in sections on the outer surface of the roller core.

The invention further relates to a roller assembly for use in a dry coating process to produce electrodes, which has two rollers fonning a roller gap between them, of which at least one roller is designed as a roller of any one of the preceding claims, which furthermore has at least two detection devices spaced apart from one another orthogonally to the conveying direction of the electrode for detecting the thickness of the electrode produced in the roller gap, wherein the roller assembly firther comprises a control device which is designed to compare the at least two detected actual thicknesses with a target thickness and, when a deviation of one of the actual thicknesses from the target thickness is detected, the tempering zone assigned to the respective detection device is controlled by the control device in such a way that the respective actual thickness is brought closer to the target thickness.

It can be provided that at least one respective detection device is assigned to each tempering zone. The detection device can be a sensor for detecting the electrode thickness. The sensors for measuring the thickness of the generated electrode, which are regularly spaced across the width of the roller gap, can be part of a control system which controls the individual tempering zones in response to the individual thickness measurement values recorded in the different tempering zones to continuously bring the generated electrode thickness closer to a target value. The detection device can also be a temperature sensor, which detects the respective temperature in the respective tempering zones. It can be provided that the generated electrode thicknesses are known as a function of the temperature, so that when a temperature is detected in a tempering zone, the thickness of the electrode generated in this area is known or can be derived from the detected temperature.

Using the tempering zones, it is possible to control the temperature expansion in the roller body in such a way that the roller gap between the two rollers can be adjusted as evenly as possible across the entire roller width, or that crowning is avoided or corrected.

The invention further relates to a method of manufacturing an electrode, comprising the steps of: contacting an electrode precursor material with a roller, wherein the roller comprises: a roller core consisting of a core material; a roller shell consisting of a shell material, the roller shell surrounding the roller core at least in sections; wherein the roller material has a greater hardness than the core material; and wherein the roller core comprises a tempering device for tempering the roller shell.

The device for tempering the roller shell can include a plurality of independently segmented tempering zones in the axial direction of the roller, wherein individual temperatures can be set in the individual tempering zones, the method further possibly including the step of: setting the temperature in at least one tempering zone independently of the other tempering zones.

The invention further relates to a method of manufacturing an electrode, comprising the steps of:
by means of a roller assembly which has two rollers forming a roller gap between them and at least two detection devices for detecting a thickness:
bringing an electrode precursor material into contact with the roller assembly;
detecting the thickness of an electrode formed in the roller gap with at least one of the detection devices;
and adjusting the temperature of at least one of the rollers based on the electrode thickness detected.

The invention further relates to an electrochemical laminate comprising at least one electrode layer formed by calendering an electrode precursor material with a roller comprising:
a roller core consisting of a core material;
a roller shell consisting of a shell material, the roller shell surrounding the roller core at least in sections;
the shell material having a greater hardness than the core material;
and the roller core including a device for tempering the roller shell.

Exemplary embodiments of the invention are explained with reference to the following figures. In particular:

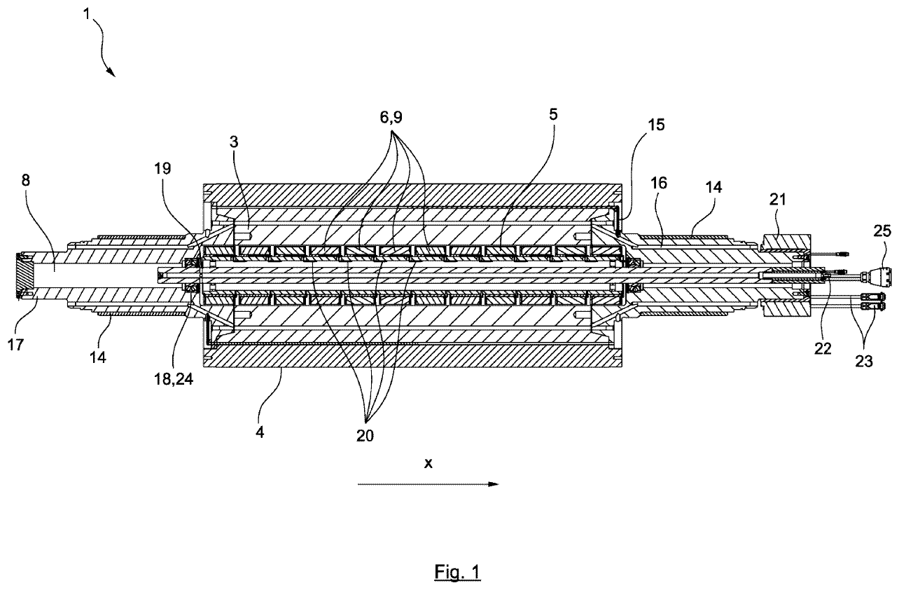

FIG. 1 shows a cross-sectional view of an embodiment of the roller according to the invention;

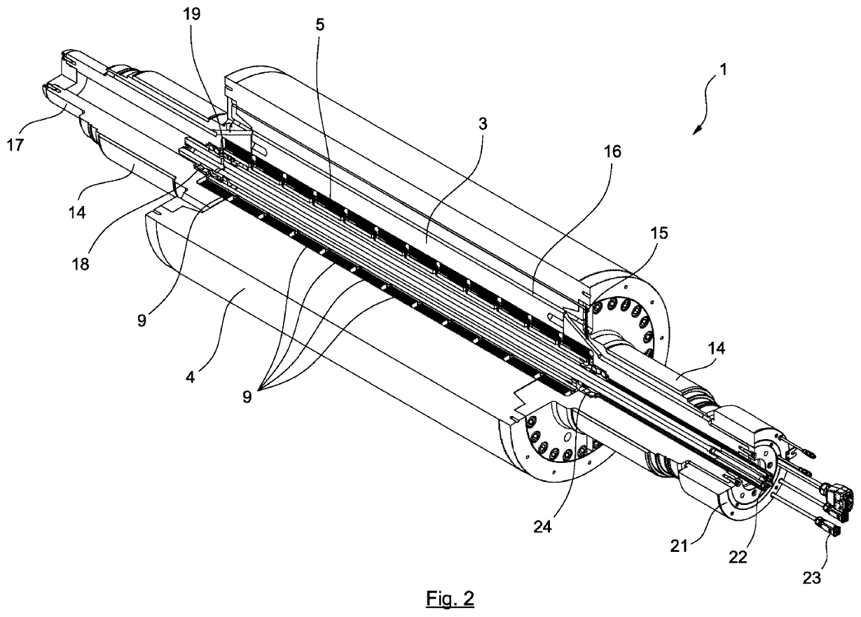

FIG. 2 shows a perspective view of an embodiment of the roller according to the invention in half section;

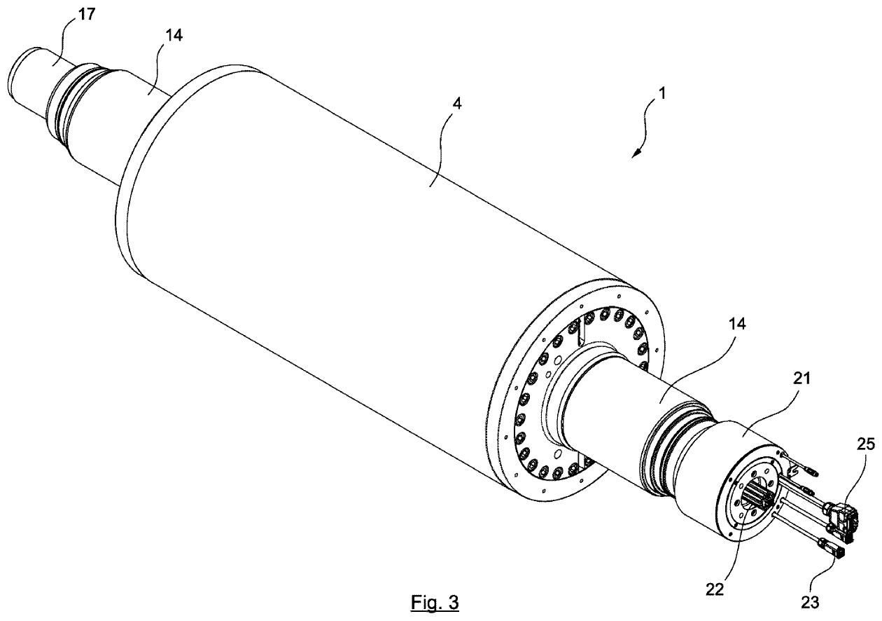

FIG. 3 shows a perspective view of an embodiment of the roller according to the invention;

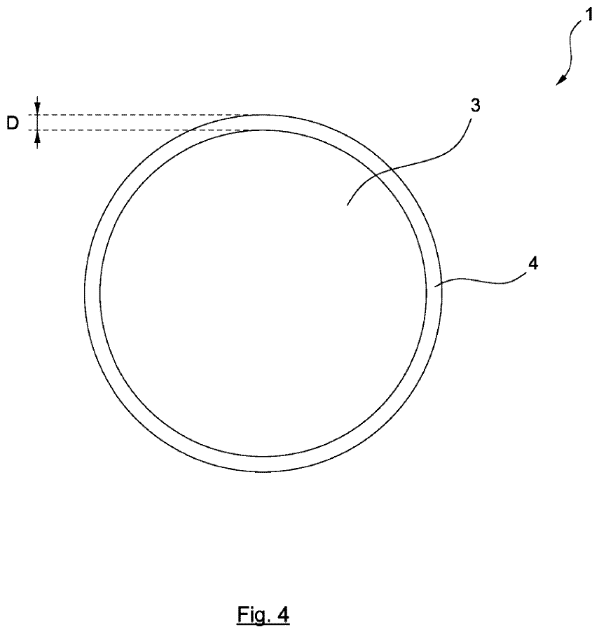

FIG. 4 shows a schematic cross-sectional view of an embodiment of the roller according to the invention;

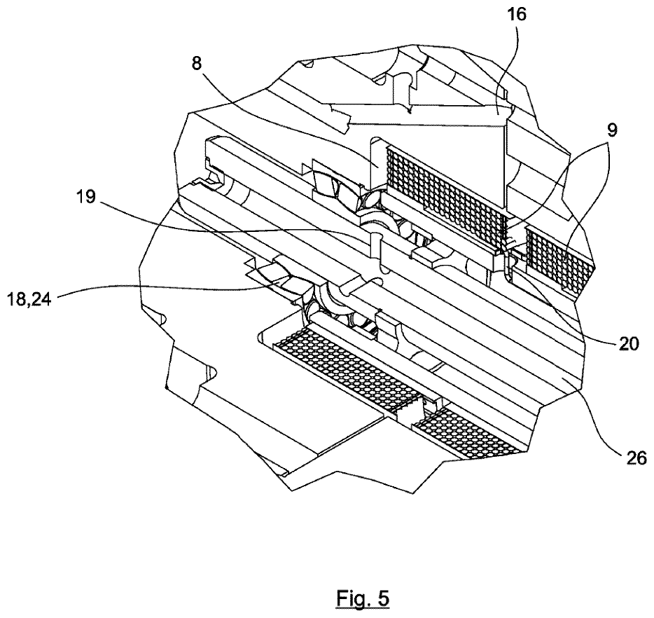

FIG. 5 shows a detailed view of an embodiment of a tempering zone of the roller according to the invention.

FIG. 1 shows a cross-sectional view of an embodiment of the roller 1 according to the invention, which can be used in a dry coating process to produce electrodes. The roller 1 has a roller body which is formed by a roller core 3 and a roller shell 4. The roller core 3 essentially consists of a soft core material. The roller core 3 is surrounded by the roller shell 4, which essentially consists of a shell material. An axial bore 8 is provided in the roller core, defining a cavity in the roller core 3. A device 5 for tempering the roller shell 4 is accommodated in the axial bore. The device 5 for tempering the roller shell 4 has a plurality of independently segmented tempering zones 6 in the axial direction X of the roller 1, wherein individual temperatures can be set in the individual tempering zones 6. In the embodiment shown, the device 5 for tempering the roller shell 4 has a total of twelve tempering zones 6, each tempering zone 6 being formed by a separate inductor 9. All inductors 9 have the same dimensions and are spaced apart by the same distance. Furthermore, each inductor 9 has a separate voltage connection 20 and a separate temperature sensor 15 is assigned to each inductor. The recorded temperature data is transmitted via a data cable 23 to a higher-level control unit, which compares the actual values received with the respective target values and consequently regulates the power supply to the individual inductors 9. This makes it possible to set an individual temperature in each tempering zone 6. When the temperature is increased, the material of the roller core 3 and the roller shell 4 expands, so that the outer diameter of the roller 1 is correspondingly increased and, as a result, the roller gap between the two rollers 1, between which the electrode material is passed, is reduced. By providing several individually controllable tempering zones 6, it is therefore possible to individually influence the outer diameter of the roller 1, and accordingly the roller gap, across the entire width of the roller gap in sections in the individual tempering zones 6. The inductors 9 are mounted at regular intervals from one another on a support axis 18, which is accommodated in the axial bore 8 of the roller 1. The support axis 18 is mounted in the axial bore 8 via spherical roller bearings 24, so that the support axis 18 together with the inductors 9 mounted on it can be rotated relative to the roller body. During operation, the roller body, i.e. the roller core 3 together with the roller shell 4 surrounding it, rotate around the stationary support axis 18 with the inductors 9 mounted on it. The support axis 18 itself also has an axial bore, which is used to pass through cooling air to protect the inductors 9 or their electrical connections 20 against overheating. On one end of the roller 1, the support axis 18 has a compressed air connection 22 to feed the axial bore of the support axis 18 with cooling air. On the opposite end, the cooling air duct has radial holes which serve as an air outlet 19 for the compressed air. Axially opposite the roller body are bearing points 14, via which the roller 1 is mounted. A journal 17 protrudes beyond this point in each case. Moreover, a slip ring 21 is mounted on one of the journals 17 shown on the right in the illustration, ensuring electrical power or signal transmission between the components rotating against one another. Connected to the slip ring are data cables 23 for signal transmission between the temperature sensors and the control unit as well as a power connection 25 between the control unit and the individual inductors 9. The roller core 3 also includes cooling bores 16, which run essentially parallel to the roller axis X in the area of the roller body. In the area of the bearing points 14, the cooling bores 16 run at a smaller distance from the roller axis X. Between the cooling bores 16 of the roller core 3 and the cooling bores 16 of the bearing points 14, obliquely extending connecting channels are provided, which connect the cooling bores 16 of the roller core 3 with the cooling bores 16 of the bearing points 14.

FIG. 2 shows a perspective view of the embodiment of the roller according to the invention from FIG. 1 in half section. The roller 1 has journals 17 at each of its outer ends, which are connected to bearing points 14 which are directly adjacent to the roller body. A slip ring 21 is mounted on the lower journal 17 shown in the figure, to which lines for transmitting electrical power or signals are connected. Also visible is the support axis 18 extending through the roller body, on which the twelve inductors 9 are mounted. It can be seen that the inductors 9 each surround the support axis 18 in a ring shape. The support axis 18 extends on the side of the roller 1 that has the slip ring 21 as far as the end face and protrudes from the journal 17. This is where the air connection 22 for supplying the axial bore of the support axis 18 provided for the air guide with cooling air for cooling the inductors 9 is located. It can also be seen that the bearing points 24 of the support axis 18 are each arranged between the roller body and the bearing points 14 in the axial direction X. It is also visible that the support axis 18 has a plurality of air outlets 19 in the immediate vicinity of the bearing point 24 of the support axis 18, which are aligned radially in different directions.

FIG. 3 shows a perspective view of an embodiment of the roller 1 according to the invention. It essentially has a roller body consisting of a roller core 3 and a roller shell 4, the roller shell being made of a harder material than the roller core 3. The roller shell 4 provides the roller surface, which is used to generate the electrodes in the roller gap. The roller body is axially connected to bearing points 14, via which the roller 1 can be rotationally supported. One of the bearing points 14 is connected to a journal 17, via which the roller 1 can be driven. The other bearing point 14 is connected to a slip ring 21, into which connections for power and signal transmission lead. On the one hand, a data cable 23 leads into the slip ring, via which the data cable 23 is connected to a control unit. On the other hand, a power cable 25 leads into the slip ring, via which the inductors 9 inside the roller body can be individually supplied with power.

FIG. 4 shows a schematic cross-sectional view of the roller 1 for use in a dry coating process for producing electrodes 2. It essentially comprises, on the one hand, a roller core 3 consisting of a core material that is an easily machinable steel. The steel of the core material can, for example, be a heat-treatable steel, such as 42CrMo4 in particular, or also a case-hardening steel. On the other hand, the roller 1 comprises a roller shell 4, which surrounds the roller core 3 in a ring. The roller shell 4 consists of a shell material which has a greater hardness than the core material. The hardness of the roller shell 4 is at least 53 HRC (hardness according to Rockwell, scale C), preferably at least 57 HRC, particularly preferably at least 62 HRC. For example, the roller shell 4 can be made of a curable steel, such as a cold work steel. The surface of the roller shell is through-hardened to a depth of at least 5 mm. In the embodiment shown, the roller shell 4 and the roller core 3 are designed as separate components and the tubular roller shell 4 is friction-locked to the roller core 3. The roller shell 4 is fixed to the roller core 3 by shrinking on the roller shell 4 and/or by cold expansion of the roller core 3. The roller shell 4 has a wall thickness D of at least 10 mm, preferably at least 15 mm, particularly preferably at least 20 mm. The roller shell 4 is preferably through-hardened across the entire cross-section of the tube wall.

FIG. 5 shows a detailed view of an embodiment of the roller 1 according to the invention in half section. It shows in particular a section through the inductor 9 as well as the support axis 18 and its bearing 24. It can be seen that the copper coils or inductors 9 have a plurality of copper wires. The number and thickness of the copper wires per inductor can be determined in such a way that the heating power required to regulate the roller gap can be achieved. Each inductor 9 has its own electrical connection 20 so that each inductor 9 has its own power supply and the resulting different tempering zones 6 can be used to control the deflection of the roller 1. A small distance is provided between each of the inductors. It can be seen that the support axis 18 accommodated in the axial bore 8 of the roller 1 is mounted relative to the roller 1 via a spherical roller bearing 24. The air duct formed in the support axis 18 has a plurality of air outlets 19 extending radially away from the air duct, which open into the interior of the roller 1, in which the inductors 9 are accommodated. The air outlets 19 serve to cool this interior.

The features of the invention disclosed in the above description, in the figures and in the claims can be essential for the realization of the invention either individually or in any combination.

### LIST OF REFERENCE NUMERALS

1 roller
2 electrode
3 roller core
4 roller shell
5 device for tempering the roll shell
6 tempering zone
7 heating or cooling element
8 axial bore
9 inductor
10 fluid channels
11 roller assembly
12 roller gap
13 detection device for detecting the thickness of the electrode
14 bearing point
15 temperature sensor
16 cooling bore
17 journal
18 support axis
19 air outlet
20 electrical connection
21 slip ring
22 air connection
23 data cable
24 spherical roller bearing
25 power cable
26 air duct

1. A roller for use in a dry coating process to produce electrodes, comprising:
a roller core consisting of a core material;
a roller shell consisting of a shell material, the roller shell surrounding the roller core at least in sections;
wherein the shell material has a greater hardness than the core material;
and wherein the roller core has a device for tempering the roller shell.

2. A roller for use in a dry coating process to produce electrodes, comprising:
a roller core consisting of a core material;
a roller shell consisting of a shell material, the roller shell surrounding the roller core at least in sections;
wherein the shell material has a greater hardness than the core material;
wherein the roller shell and the roller core are designed as separate components and the essentially tubular roller shell is attached to the roller core in a force-fit and/or form-fit manner;
and wherein the roller shell consists of a curable steel, such as a cold work steel, and is through-hardened on its surface at least to a depth of at least 5 mm.

3. A roller for use in a dry coating process to produce electrodes, comprising:
a roller core consisting of a core material;
a roller shell) consisting of a shell material, wherein the roller shell surrounds the roller core at least in sections;
and wherein the roller core has a device for tempering the roller shell;
wherein the device for tempering the roller shell has a plurality of independently segmented tempering zones in the axial direction (X) of the roller, wherein individual temperatures can be set in the individual tempering zones.

4. The roller claim 1, wherein the shell material is applied as a coating to the roller core or the roller shell.

5. The roller of claim 4, wherein the coating comprises chromium, diamond-like carbon, tungsten carbide or a metal matrix composite such as a tungsten carbide/cobalt alloy or a chromium carbide/nickel-chromium composite.

6. The roller of claim 1, wherein the roller shell has a hardness of at least 53 HRC, preferably at least 57 HRC, particularly preferably at least 62 HRC.

7. The roller of claim 1, wherein the roller shell and the roller core are designed as separate components and the essentially tubular roller shell is attached to the roller core in a force-locking and/or form-locking manner.

8. The roller of claim 7, wherein the roller shell is fixed to the roller core by means of shrinking and/or cold expansion.

9. The roller of claim 7, wherein the roller shell is fixed on the roller core by means of a clamping connection.

10. The roller of claim 1, wherein the roller shell has a wall thickness (D) of at least 10 mm, preferably at least 15 mm, particularly preferably at least 20 mm.

11. The roller of claim 1, wherein the roller shell consists of a curable steel, such as a cold work steel, and is through-hardened on its surface to a depth of at least 5 mm.

12. The roller of claim 11, wherein the roller shell is through-hardened across the entire tube wall cross-section.

13. The roller of claim 1, wherein the roller core consists of an easily machinable steel, such as a heat-treatable steel, such as 42CrMo4, or a case-hardening steel.

14. The roller of claim 1, wherein the device for tempering the roller shell comprises at least one heating and/or cooling element integrated in the roller core.

15. The roller of claim 1, wherein the device for tempering the roller shell provides a plurality of independently segmented tempering zones in the axial direction (X) of the roller, wherein individual temperatures can be set in the individual tempering zones.

16. The roller of claim 1, wherein the roller core has an axial bore, in which the heating and/or cooling element is accommodated.

17. The roller of claim 1, wherein the device for tempering the roller shell is an inductive heating element.

18. The roller of claim 1, wherein the device for tempering the roller shell is a temperature radiator received in the axial bore of the roller core.

19. The roller of claim 1, wherein the roller core has functional bores formed as fluid channels, which extend at least in sections on the outer surface of the roller core.

20. A roller assembly for use in a dry coating process for producing electrodes, comprising two rollers forming a roller gap between them, of which at least one roller is designed as a roller of any one of the preceding claims,
and further comprising at least two detection devices spaced apart orthogonally to the conveying direction of the electrode for detecting the thickness of the electrode produced in the roller gap,
wherein the roller assembly also includes a control device which is designed to compare the at least two detected actual thicknesses with a target thickness and, when a deviation of one of the actual thicknesses from the target thickness is detected, the tempering zone assigned to the respective detection device is actuated by the control device in such a way that the respective actual thickness is brought closer to the target thickness.

21. The roller assembly of claim 20, wherein at least one respective detection device is assigned to each tempering zone.

22. A method of manufacturing an electrode, comprising the steps of:
contacting an electrode precursor material with a roller, the roller including:
a roller core consisting of a core material;
a roller shell consisting of a shell material, the roller shell surrounding the roller core at least in sections;
wherein the roller material has a greater hardness than the core material;
and wherein the roller core has a tempering device for tempering the roller shell.

23. The method of claim 22, wherein the device for tempering the roller shell has a plurality of independently segmented tempering zones in the axial direction (X) of the roller, wherein individual temperatures can be set in the individual tempering zones, the method further comprising the step of:
setting the temperature in at least one tempering zone independently of the other tempering zones.

24. A method of manufacturing an electrode, comprising the steps of:
by means of a roller assembly, which has two rollers forming a roller gap between them and at least two detection devices for detecting a thickness:
bringing an electrode precursor material into contact with the roller assembly;
detecting the thickness of an electrode formed in the roller gap with at least one of the detection devices;
and adjusting the temperature of at least one of the rollers based on the detected electrode thickness.

25. An electrochemical laminate comprising at least one electrode layer formed by calendering an electrode precursor material with a roller comprising:
a roller core consisting of a core material;
a roller shell consisting of a shell material, the roller shell surrounding the roller core at least in sections;
wherein the shell material has a greater hardness than the core material;
and wherein the roller core has a device for tempering the roller shell.
